(19) United States
(12) Patent Application Publication
(10) Pub. No.: US 2017/0147932 A1
(43) Pub. Date: May 25, 2017

(54) SYSTEM AND METHOD FOR PREDICTING COLLAPSE OF STRUCTURE USING THROW-TYPE SENSOR

(71) Applicant: Korea Advanced Institute of Science and Technology, Daejeon (KR)

(72) Inventors: Hoon SOHN, Daejeon (KR); Min-Koo KIM, Daegu (KR); Seong-Heum YOON, Daejeon (KR)

(73) Assignee: Korea Advanced Institute of Science and Technology, Daejeon (KR)

(21) Appl. No.: 15/348,141

(22) Filed: Nov. 10, 2016

(30) Foreign Application Priority Data
Nov. 19, 2015 (KR) 10-2015-0162177

(51) Int. Cl. G06N 5/04; G01B 11/00; G06F 17/50; G01C 21/20; A62C 99/00; G01B 5/004; G01C 21/10

(52) U.S. Cl. CPC G06N 5/047; G01B 5/004; G01B 11/002; G01C 21/10; G01C 21/206; A62C 99/009; G06F 17/5004

(57) ABSTRACT

Disclosed are a method for predicting collapse of a structure using throw-type sensors and a system for the same. The system includes at least one throw-type sensor for measuring a collapse characteristic of a structure on fire after having been thrown into the structure in a fireplace and wirelessly transmitting measured data, and a computer for receiving the measured data transmitted from the at least one throw-type sensor and predicting whether or not the structure on fire will collapse by analyzing the measured data.

### CROSS-REFERENCE TO RELATED APPLICATION

This application claims priority under 35 USC §119 to Korean Patent Application No. 10-2015-0162177, filed on Nov. 19, 2015 in the Korean Intellectual Property Office (KIPO), the contents of which are herein incorporated by reference in their entirety.

### BACKGROUND

1. Technical Field

The present invention relates to a technology for predicting collapse of a structure using a throw-type sensor. In particular, the invention relates to a method for collecting collapse characteristic data of the structure on fire through the throw-type sensors which are directly thrown to the structure, and predicting possible collapse of the structure by analyzing the collected collapse characteristic data, and a system for the same.

2. Description of the Related Art

In the fireplace, the main cause of casualties may include burns by fire, suffocation by smoke, and collapse of the structure, etc. In spite of the potential collapse of the structure on fire, the fire-fighters have to take such a risk for life-saving, which results in lots of damages of the fire-fighters.

The conventional technologies for the structure collapse prediction use a displacement sensor or an accelerometer for sensing deflection and slope of the structure on fire to predict possible collapse of the structure.

However, displacement of the structure is referred to a relative value about the original point which represents a structure's moved-position off the original point by the vibration. Therefore, the displacement sensor should be placed and fixed at a position where there is no vibration or movement, such as the ground. As an example, for the use of a linear variable differential transformer (LVDT) it should be linked with a temporary-erected steel structure and a laser Doppler vibrometer (LDV) should be installed at a fixed position on the ground to point the laser at a measurement point. However, it is difficult to use these sensors in a special environment such as the fireplace. In the fireplace, it may be very difficult to find the installation position of the fixed-position type displacement sensor or to install it. Besides, the long-distance measurement with the LDV may not ensure the accuracy of its measurement because there are a lot of visual obstacles such as dust or smoke between the measuring point and the sensor.

In the double integral of the accelerometer data, errors may be quickly accumulated due to an inherent bias of the accelerometer (a phenomenon that the origin is not exactly aligned with zero). A solution for precisely correcting the bias error has not been developed yet, which thus makes it difficult to calculate the exact displacement.

### SUMMARY

In order to solve these problems of the above-mentioned conventional technologies, embodiments of the present inventive concept provide a throw-type sensor based structure collapse prediction method and a system for the same that can collect collapse characteristic data of the structure from the throw-type sensors by directly throwing the sensors to collapse vulnerable positions in the fireplace.

In addition, some embodiments of the present inventive concept provide a throw-type sensor based structure collapse prediction method and a system for the same that can allow the accurate measurement of the displacement of the structure by removing the bias errors from the double integral using the accelerometer.

Some other embodiments of the present inventive concept further provide a throw-type sensor based structure collapse prediction method and a system for the same that can allow the further accurate prediction of structure collapse by synthesizing measurement signals and structural analysis results in accordance with temperature.

Furthermore, some other embodiments of the present inventive concept provide a throw-type sensor based structure collapse prediction method and a system for the same that can analyze an estimated collapse time and provide early warning to the firefighters in the fireplace in real time based on the analysis result.

However, the problems to be solved by the present inventive concept are not limited to the above, and it may be variously extended without departing from the spirit and scope of the present inventive concept.

According to exemplary embodiments of the present inventive concept, there is provided a structure collapse prediction system which includes at least one throw-type sensor for measuring a collapse characteristic of a structure on fire after having been thrown into the structure in a fireplace and wirelessly transmitting measured data, and a computer for receiving the measured data transmitted from the at least one throw-type sensor and predicting whether or not the structure on fire will collapse by analyzing the measured data.

In an exemplary embodiment of the present inventive concept, the throw-type sensor may include an accelerometer, and a velocimeter, and transmit acceleration data and velocity data measured by the accelerometer and the velocimeter, respectively, to the computer. In addition, the throw-type sensor may further include at least any one among a GPS sensor, a camera and a temperature sensor.

In addition, the computer may include a sensor position estimating unit for calculating a 3-dimensional (3D) absolute coordinate of a position of the at least one throw-type sensor based on GPS data, and estimating the position of the at least one throw-type sensor on a design drawing of the structure by figuring out a structural element of the structure on which the at least one throw-type sensor is positioned based on image data from the camera.

In an exemplary embodiment, the computer may include a displacement estimation unit for correcting a bias value of the received acceleration data and velocity data. The displacement estimation unit may include a Kalman filter for calculating the velocity data by integrating once the acceleration data measured by the throw-type sensor, and the bias value by linearly combining the calculated velocity data and the velocity data measured by the throw-type sensor, and a bias compensator for offsetting the bias value included in displacement data obtained by integrating twice the measured acceleration data by the calculated bias value to obtain bias-error-free displacement data.

In an exemplary embodiment, the computer may a collapse prediction unit for extracting collapse sign characteristic data from the bias-error-free displacement data estimated by the displacement estimation unit and predicting a potential collapse portion of the structure on fire through a pattern-recognition based structural analysis based on the extracted collapse sign characteristic data. In the present inventive concept, the collapse sign characteristic data may include displacement data, natural frequency data and damping ratio data.

In an exemplary embodiment, it is preferable that the computer includes a collapse warning unit for estimating a potential collapse time of the structure based on an analysis result by the collapse prediction unit, and warning a remaining time till the estimated potential collapse time.

In an exemplary embodiment, the throw-type sensor may include a fire-resistant shell. The throw-type sensor may be thrown by hand or using a separate throwing tool.

According to exemplary embodiments of the present inventive concept, there is provided a method for predicting collapse of a structure on fire by throwing a plurality of throw-type sensors into the structure. The method includes the steps of communicating, by a computing device, with a plurality of throw-type sensors thrown into the structure on fire to receive measured data for a collapse characteristic of the structure from each of the plurality of the throw-type sensors, and predicting, by the computing device, whether or not the structure on fire will collapse by analyzing the measured data for the collapse characteristic of the structure.

In an exemplary embodiment, the measured data for the collapse characteristic of the structure may include acceleration data, velocity data and position data.

In an exemplary embodiment, the predicting step may include the steps of: estimating, by the computing device, attached positions of the throw-type sensors on the structure based on position data received from the throw-type sensors; calculating, by the computing device, displacement data without a bias error which is removed by combining acceleration data and velocity data received from the plurality of throw-type sensors at their attached positions on the structure; and estimating, by the computing device, a potential collapse portion of the structure on fire based on the calculated displacement data.

In an exemplary embodiment, the predicting step may include a step of correcting a bias value of the received acceleration data and velocity data.

In an exemplary embodiment, the predicting step may include the steps of: calculating a velocity data by integrating once the acceleration data measured by each of the plurality of throw-type sensors, and a bias value by linearly combining the calculated velocity data and the velocity data measured by the throw-type sensor; and offsetting the bias value included in the displacement data obtained by integrating twice the measured acceleration data by the calculated bias value to obtain the displacement data without the bias error.

In an exemplary embodiment, the predicting step may include the steps of: extracting a collapse sign characteristic from the displacement data, and predicting a potential collapse portion of the structure on fire through a pattern-recognition based structural analysis based on the extracted collapse sign characteristic.

In an exemplary embodiment, the collapse sign characteristic may include a displacement, a natural frequency and a damping ratio.

In an exemplary embodiment, the method may further including a step of estimating, by the computing device, a potential collapse time based on an analysis a collapse prediction algorithm.

In an exemplary embodiment, the method may further including a step of warning a remaining time till the estimated potential collapse time.

In an exemplary embodiment, the method may further including the steps of: calculating a 3-dimensional absolute coordinate of positions of the plurality of throw-type sensors based on GPS data; and estimating the positions of the plurality of throw-type sensors on a design drawing of the structure by figuring out a structural element of the structure on which the plurality of throw-type sensors are positioned based on image data from a camera in each of the plurality of throw-type sensors.

The structure collapse prediction system and method according to the exemplary embodiments of present inventive concept can obtain highly reliable displacement data from which the bias error is removed by calculating a bias value based on the linear combination of the acceleration data and the calculated velocity data and removing the bias value from the displacement data obtained by the double integral of the acceleration data by the calculated bias value. Therefore, the exemplary embodiments of the present inventive concept can make it possible to predict more accurately potential collapse of the structure on fire.

However, the effects of the exemplary embodiments of the present inventive concept are not limited to the above-mentioned effects, and it may be expanded in various ways without departing from the spirit and scope of the invention.

### BRIEF DESCRIPTION OF THE DRAWINGS

Illustrative, non-limiting example embodiments will be more clearly understood from the following detailed description taken in conjunction with the accompanying drawings.

FIG. 1 is a conceptual view of a throw-type sensor based structure collapse prediction system according to an exemplary embodiment of the present inventive concept.

FIG. 2 is a perspective view of the throw-type sensor according to an exemplary embodiment, shown in FIG. 1, of which shell is partially cut away.

FIG. 3 is a block diagram of the throw-type sensor shown in FIG. 1 according to an exemplary embodiment.

FIG. 4 is a block diagram of a computer shown in FIG. 1 according to an exemplary embodiment.

FIG. 5 is a detailed block diagram of a displacement estimation unit shown in FIG. 4 according to an exemplary embodiment.

FIG. 6 is a flowchart for describing operations of the computer according to an exemplary embodiment.

FIGS. 7 to 9 are situation diagrams for describing operations of the computer according to an exemplary embodiment.

FIG. 10 illustrates graphical views for describing extraction of collapse sign characteristics of the structure on fire by the collapse prediction unit according to an exemplary embodiment.

FIG. 11 illustrates a view for describing a process of estimating an expected potential collapse portion through structural analysis by the collapse prediction unit according to an exemplary embodiment.

FIG. 12 is a graph of estimated remaining time till collapse for early warning collapse of the structure on fire by the collapse warning unit, according to an exemplary embodiment.

### DETAILED DESCRIPTION OF THE EMBODIMENTS

Advantages and features of the present inventive concept and methods of accomplishing the same will become apparent with reference to the embodiments that will be described below in detail, along with the accompanying drawings. The present inventive concept may, however, be embodied in many different forms and should not be construed as limited to the exemplary embodiments set forth herein. Rather, these exemplary embodiments are provided so that this disclosure will be thorough and complete, and will fully convey the scope of the present inventive concept to those skilled in the art. In the drawings, the sizes and relative sizes of layers and regions may be exaggerated for clarity.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” “include” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

With reference to the accompanying drawings, preferred embodiments of the present inventive concept will be described in detail. The same numeral reference will be assigned to the same element in the drawings.

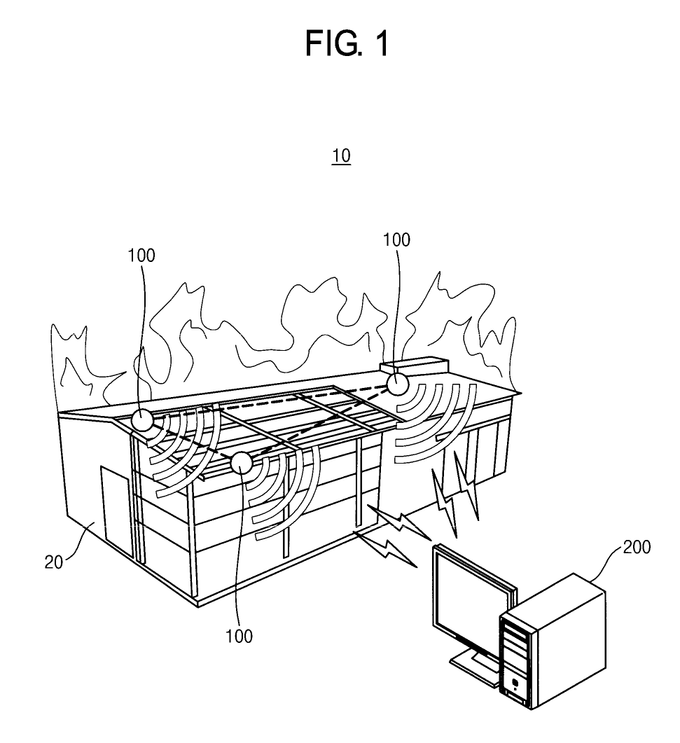

FIG. 1 illustrates a conceptual view of a throw-type sensor based structure collapse prediction system according to an exemplary embodiment. With reference to FIG. 1, the throw-type sensor based structure collapse prediction system 10 includes a plurality of throw-type sensors 100 thrown on a structure 20 on fire and a computer 200.

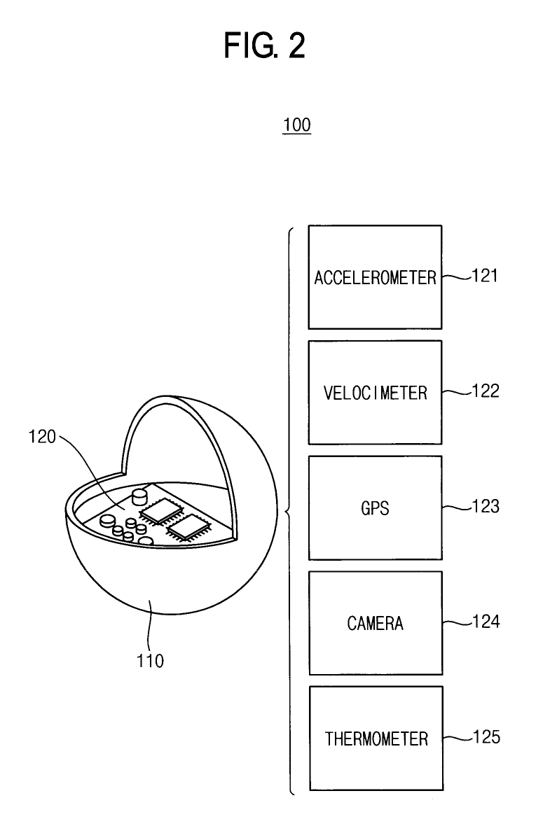

FIG. 2 illustrates a perspective view of the throw-type sensor in FIG. 1 of which shell is partially cut away according to an exemplary embodiment. With reference to FIG. 2, the throw-type sensor 100 may include, within a fire-resistant shell 110, a printed circuit board in which several kinds of sensors, a communication unit, a battery, a processor, etc. may be installed. The sensors may include an accelerometer, a velocimeter, a GPS module, a camera, and a thermometer. The throw-type sensor 100 may have a suitable size for throwing by hand, for example, the size of a golf ball or a tennis ball, and a shape of spherical ball type or hexahedron type. Also, the throw-type sensor 100 may include a powerful magnet installed on the shell 110 by which the sensor 100 can be attached to a metal member of the structure 20 on fire.

The computer 200 may be composed of a computing device capable of wireless Internet access and/or data communication, for example, a server computer, a desktop computer, a laptop computer, a tablet PC, or a smartphone, and can wirelessly communicate with the throw-type sensor 100.

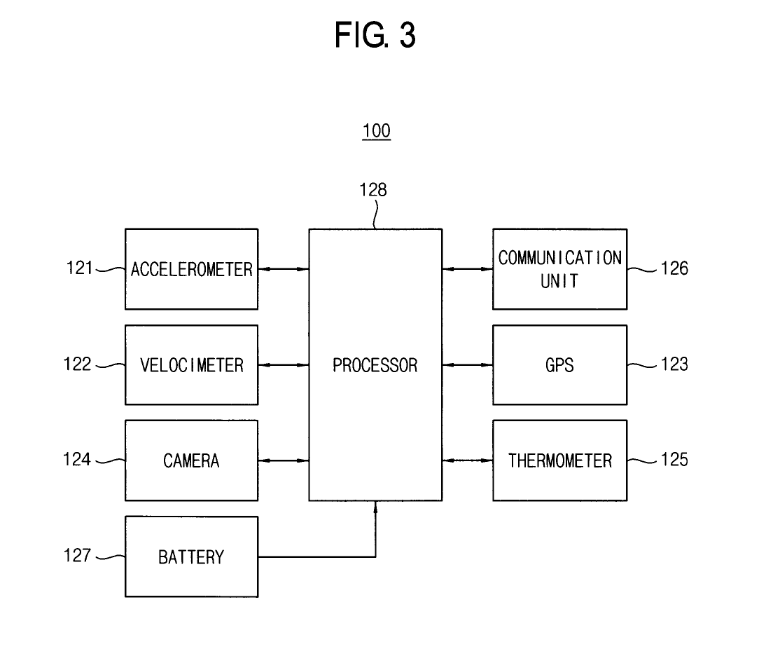

FIG. 3 illustrates a block diagram of the throw-type sensor 100 shown in FIG. 1 according to an exemplary embodiment. With reference to FIG. 3, the throw-type sensor 100 according to an exemplary embodiment may include an accelerometer 121, a velocimeter 122, a GPS module 123, a camera 124, a thermometer 125, a communication unit 126, a battery 127 and a processor 128.

The accelerometer 121 measures an acceleration of the throw-type sensor 100, and the velocimeter 122 measures a velocity of the throw-type sensor 100. The GPS module 123 calculates position information of the throw-type sensor 100, and the camera 124 takes a picture of the surrounding things of the throw-type sensor 100. The thermometer 125 measures an ambient temperature of the throw-type sensor 100. The communication unit 126 is capable of at least any one of Bluetooth communication, Wi-Fi communication, wireless LAN communication, data communication, etc. In an exemplary embodiment of the present disclosure, the communication unit 126 may use the Bluetooth communication method. The battery 127 may be a dry cell or a rechargeable battery. If the battery 127 is the rechargeable battery, it is preferable that the battery 127 is a wireless-chargeable battery. The processor 128 receives measured data from the accelerometer 121, the velocimeter 122, the GPS module 123, the camera 124 and the thermometer 125, and controls the measured data to be transmitted to the computer 200 through the communication unit 126.

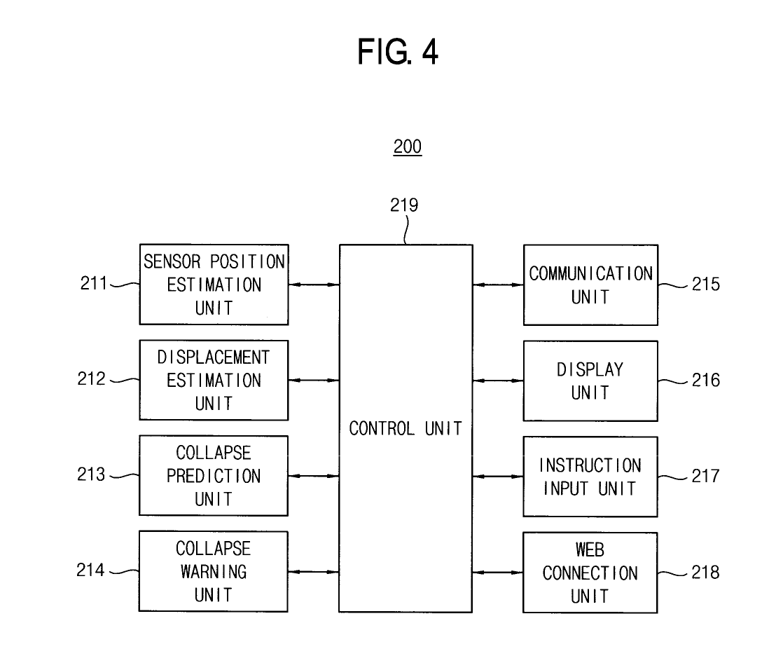

FIG. 4 illustrates a block diagram of the computer 200 shown in FIG. 1 according to an exemplary embodiment. In an exemplary embodiment, the computer 200 may include a sensor position estimation unit 211, a displacement estimation unit 212, a collapse prediction unit 213, a collapse early-warning unit 214, a communication unit 215, a display unit 216, an instruction input unit 217, a web connection unit 218, and a control unit 219.

The sensor position estimation unit 211 receives GPS data and camera image data transmitted from the throw-type sensors 100, calculating a three-dimensional absolute coordinates of the positions of the throw-type sensors 100 and estimating the positions of the throw-type sensors 100 on a design drawing of the structure 20 on fire. The design drawing of the structure 20 may be provided through the web-connection unit 218 by any external source. The sensor position estimation unit 211 can estimates positions of the sensors with an accuracy of less than 50 cm. The displacement estimation unit 212 correctly estimates dynamic displacement and cumulative displacement of each of the sensors 100 by integrating the measured acceleration data and velocity data. The collapse prediction unit 213 extracts collapse sign characteristics such as a cumulative displacement of the estimated position of each of the sensors 100, a natural frequency or damping ratio of the structure 20, performing pattern recognition based structure analysis with the collapse sign characteristics, and predicting whether or not the structure 20 on fire will collapse by calculating a measured data based collapse index. The collapse early-warning unit 214 monitors whether the collapse index calculated by the collapse prediction unit 213 reaches a threshold value of collapse and issues an early-warning of collapse of the structure 20 when the collapse index reaches the threshold value.

The communication unit 215 wirelessly communicates with the throw-type sensors 100 and receives the measured data from each of the sensors 100. The display unit 216 displays the estimated positions of the sensors 100 on the structure 20 on fire in three dimensions, and marks any risky portion at which initiation of breakdown or collapse is highly possible. Instruction input unit 217 is to notify the firefighters in or around the fireplace of the analysis result about the potential collapse of the structure 20 and/or to input a firefighting-related command for whether or not the firefighters should enter the structure 20 on fire based on the degree of collapse-risk. The web connection unit 218 manages and controls the Internet access to search any relevant data such as the location, address and design drawings of the structure 20 on fire.

The control unit 219 transfers the measured data received via the communication unit 215 to the sensor position estimation unit 211 and the displacement estimation unit 212. The control unit 219 controls the display unit 216 so as to display the analysis result from the collapse prediction unit 213 and the collapse warning unit 214.

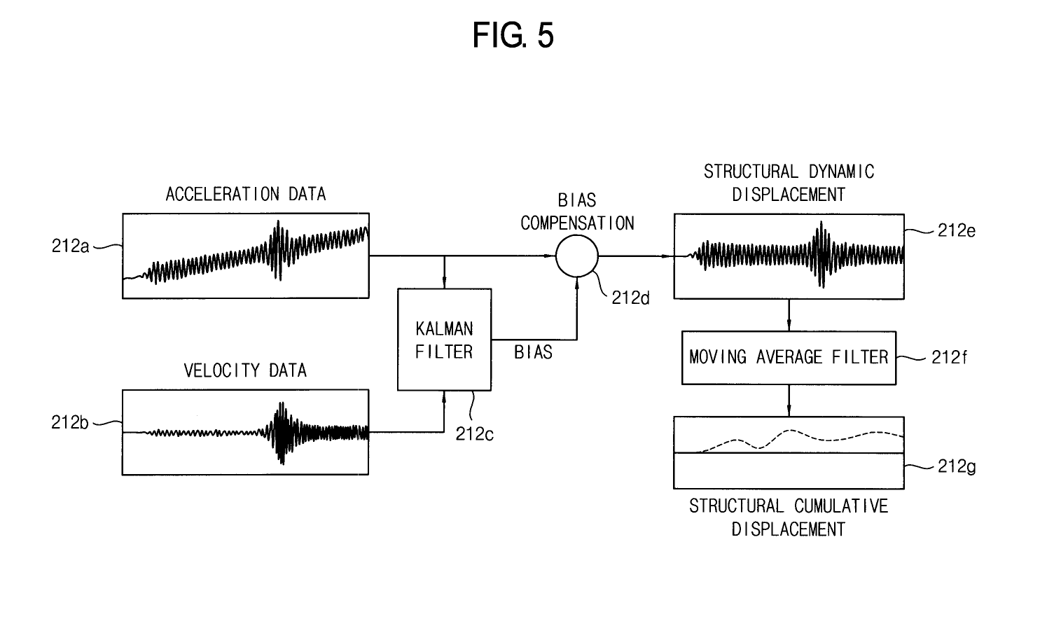

FIG. 5 illustrates a detailed block diagram of the displacement estimation unit 212 shown in FIG. 4 according to an exemplary embodiment. Referring to FIG. 5, the displacement estimation unit 212 can precisely estimates the displacement by integrating the acceleration data and the velocity data.

In an exemplary embodiment, the displacement estimation unit 212 includes an acceleration data buffer 212a, a velocity data buffer 212b, a Kalman filter 212c, a bias compensator 212d, a structural dynamic displacement calculating unit 212e, a moving average filter 212f, and a structural cumulative displacement calculation unit 212g.

The Kalman filter 212c performs the following algorithm. In the Kalman filter 212c, values of the following three parameters are considered: acceleration, velocity, and a bias value included in the acceleration data. The state space equation of the Kalman filter 212c can be obtained by establishing a physical equation including these three parameters and noises of the velocity/acceleration data.

In the typical measurement, data are measured at regular time intervals, and a measurement frequency is represented in a form of a sampling frequency. For example, if the measurement is carried out at 0.1 second intervals (Δt=0.1 sec), the measurement will be performed 10 times per second, so the sampling frequency is 10 Hz. In these data, the k^{th} time sample corresponds to the time of (k−1) Δt second.

Therefore, in the k^{th} time sample, let's assume the followings:
a true value of the acceleration: x″(k),
a true value of the velocity: x′(k),
a true value of the displacement: x(k),
a measured value of the acceleration: x″ₘ(k),
a measured value of the velocity: x′ₘ(k),
a bias value included in the measured acceleration data: b(k),
a noise value included in the measured acceleration data: w(k), and
a noise value included in the measured velocity data: v(k).

The relation between the measured velocity and acceleration data and the true values of the acceleration and velocity can be expressed by the following Equations (1) and (2).

x″ₘ(k)=x″(k)+b(k)+w(k) (1)

x′ₘ(k)=x′(k)+v(k) (2)

The velocity can be obtained by integrating the acceleration once. This can be expressed by the following equation (3).

x′(k+1)=x′(k)+x″(k)Δt (3)

In Equation (3), when Equation (3) is rewritten by substituting the acceleration x″(k) with Equation (1), the following Equation (4) can be obtained:

x′(k+1)=x′(k)+{x″ₘ(k)+b(k)+w(k)}Δt (4)

In Equation (4), the sign of b(k) and w(k) may be either plus (+) or minus (−) and Equation (4) is expressed for convenience.

On the other hand, the displacement can be obtained by integrating the acceleration twice. This relation can be expressed by Equation (5).

x(k+1)=x(k)+x′(k)Δt+½{x″ₘ(k)+b(k)+w(k)}Δt² (5)

Expressions (4) and (5) can be expressed in a form of matrix like the following Equations (6) and (7), respectively.

x(k+1)=Ax(k)+B{x″ₘ(k)+w(k)}+Hb(k) (6)

x″ₘ(k)=Cx(k)+Gb(k)+v(k) (7)

In the determinants, coefficients A, B, C, G and H can be expressed by the following Equations (8) to (12).

$$\begin{matrix}A = [ \begin{matrix}1 & Δ t \\ 0 & 1\end{matrix} & ( 8 ) \\ B = [ \begin{matrix}1 / 2 Δ {t}^{2} \\ Δ t\end{matrix} ] \begin{matrix} \\ \end{matrix} & ( 9 ) \\ C = [ \begin{matrix}0 & 1 ]\end{matrix} & ( 10 ) \\ G = [ \begin{matrix}0 & 1 ]\end{matrix} & ( 11 ) \\ H = [ \begin{matrix}1 / 2 Δ {t}^{2} & 0 \\ 0 & 0\end{matrix} ] & ( 12 )\end{matrix}$$

In the Kalman filter 212c, the displacement x(k+1), the velocity x′(k+1), and the bias b(k) can be calculated by the following process.

First, the Kalman filter 212c receives the measured acceleration data from the acceleration data buffer 212a and converts the acceleration data to the velocity data by integrating once using Equation (4).

Then, the data reliability is evaluated by calculating a variance of the noises in the measured acceleration data and the measured velocity data. It is meant that the higher the variance of the noises is, the severer the noises are. Thus, in such a situation data reliability will be lower.

Next, weight values for the velocity data converted from the acceleration data and the measured velocity data are calculated by evaluating reliabilities of both data, and a weighted velocity is newly calculated by linearly combining the two data using the calculated weight values. In this calculation, the converted velocity data may include a bias b(k), and the bias b(k) can be calculated using the weighted velocity

The bias compensator 212d calculates a finalized displacement value by applying the bias value calculated by the Kalman filter 212a to Equation (5). Therefore, it is possible to calculate the exact displacement value of which bias value is corrected.

The structural dynamic displacement calculating unit 212e calculates a dynamic displacement of the structure 20 using the displacement value calculated by the bias compensator 212d. The calculated dynamic displacement value is provided to the structural cumulative displacement calculating unit 212g through the moving average filter 212f. The structural cumulative displacement calculating unit 212g calculates a cumulative displacement of the structure 20. The calculated cumulative displacement value is provided to the collapse prediction unit 213.

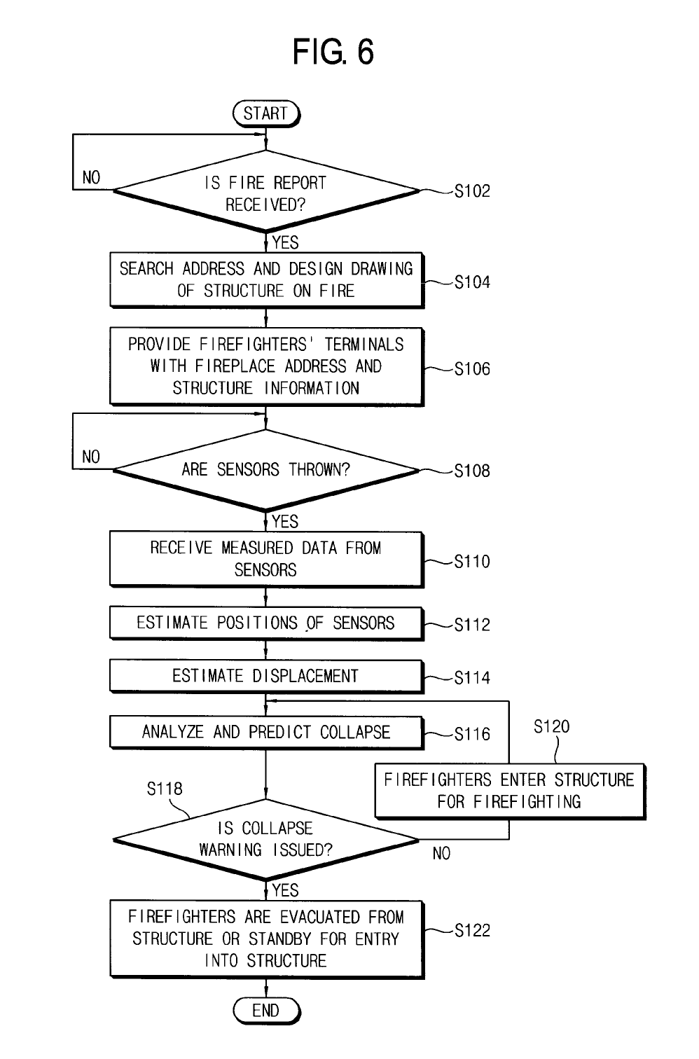

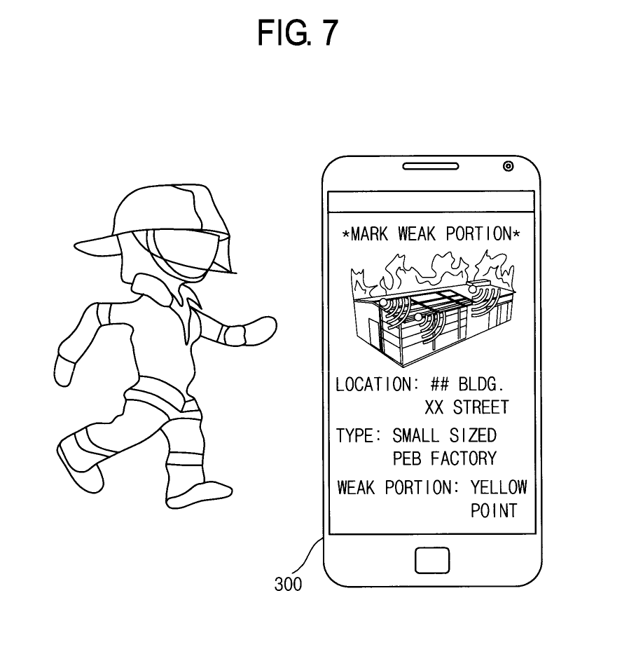

FIG. 6 illustrates a flowchart for describing the data processing by the computer 200 according to an exemplary embodiment. FIGS. 7 to 9 illustrate situation diagrams for describing operation of the computer 200 according to an exemplary embodiment. With reference to FIG. 6, the control unit 219 of the computer 200 can receive a report of fire occurrence through the communication unit 215 and/or the web connection unit 218 (Step S102). The report of fire occurrence can be originated from a system of the national fire call center. When the fire report has been received, the control unit 219 retrieves an address of the fireplace and design drawings of the structure 20 on fire (Step S104). The design drawings can be obtained from a server system of, for example, any public institution or the national fire center. The control unit 219 provides each of the terminals of the firefighters who will move to the fireplace with the necessary information about the structure 20 on fire, including the address and structural information of the structure, with reference to the design drawings of the structure 20 on fire (Step S106). The structural information of the structure 20 may include information of location, information of the structure type, information of vulnerable portions of the structure 20, etc. as shown in FIG. 7.

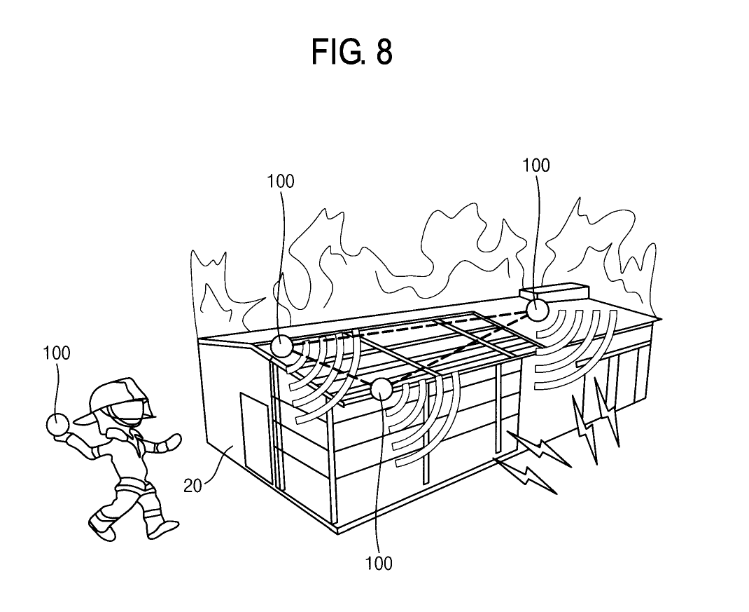

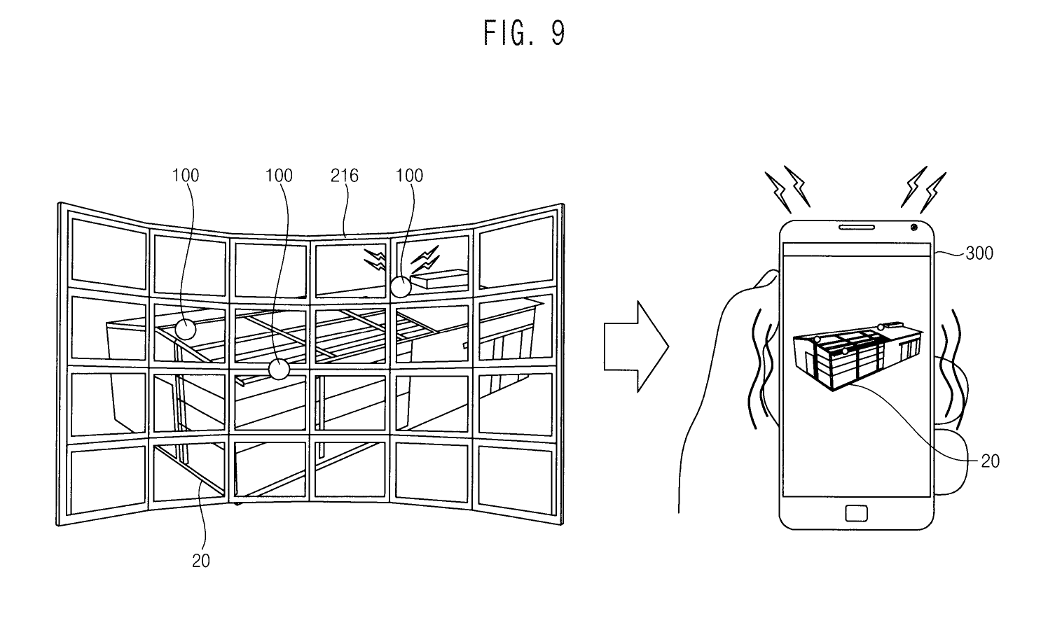

The firefighters who are present in the fireplace can throw the throw-type sensors 100 with reference to the information of vulnerable portions of the structure to collapse shown in the terminals 300 of the firefighters as shown in FIGS. 7 and 8 (Step S108). The computer 200 may receive a report on whether the sensors 100 have been thrown from the fighters' terminals 300 or may have information on whether the sensors 100 have been thrown into the structure 20 on fire through direct communication with the sensors 100. The control unit 219 initiates communication with the throw-type sensors 100 thrown into the structure 20 on fire through the communication unit 215, and receives measured data from each of the sensors 100 (Step S110). The control unit 219 provides the sensor position estimation unit 211 with GPS data from the GPS module 123 and image data from the camera 124 among the received measured data from the sensors 100. The sensor position estimation unit 211 identifies the positions of the sensors 100 attached to the structure 20 based on the GPS data and the image data, and calculates three dimensional absolute coordinates of the sensor-attached positions (Step S112). The estimated sensor-attached positions are provided to the control unit 219 and marked on the design drawings of the fired structure 20 which may be three-dimensionally displayed on the display unit 216 as shown in FIG. 9.

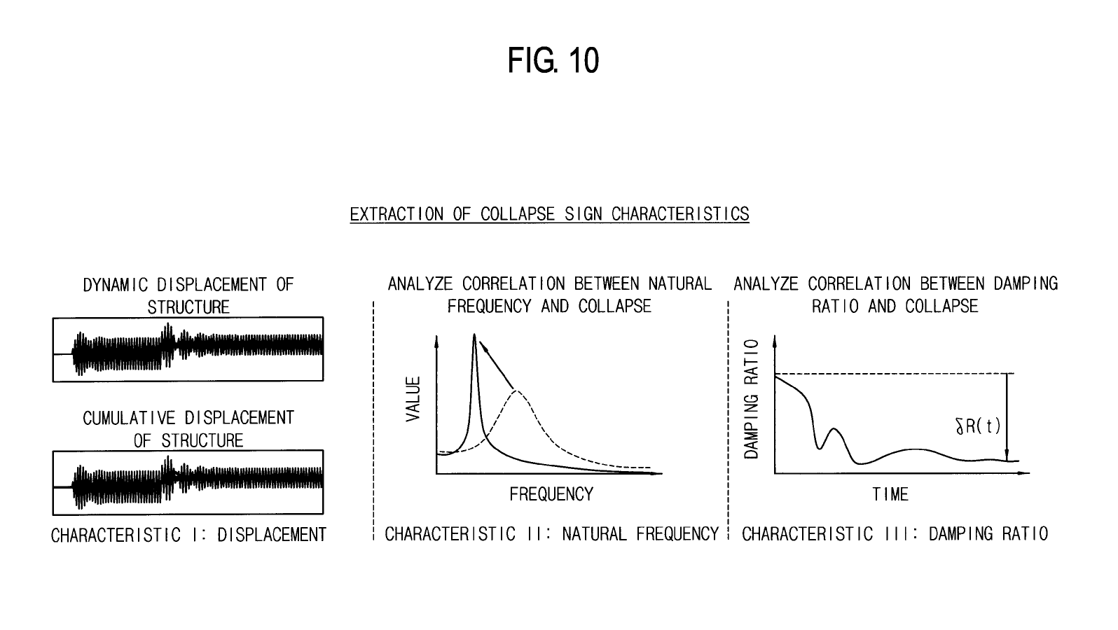

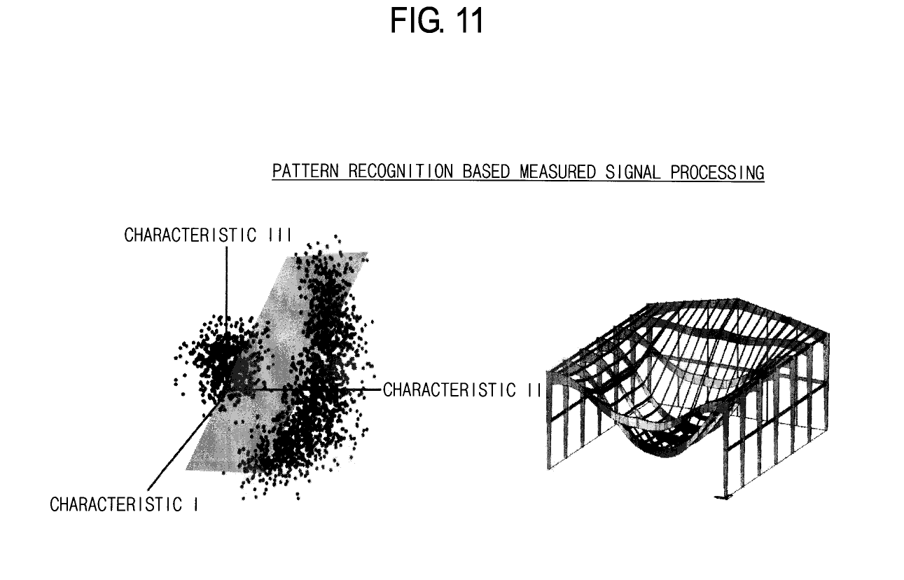

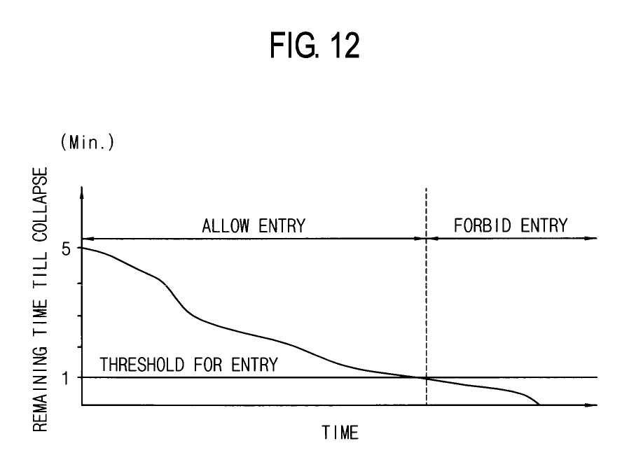

The control unit 219 provides the displacement estimation unit 212 with the acceleration data and the velocity data among the received measured data. The displacement estimation unit 212 estimates precisely the dynamic displacement and the cumulative displacement of which bias errors are compensated (Step S114). The estimated cumulative displacement data are provided to the collapse prediction unit 213. The collapse prediction unit 213 estimates any potential collapse portion of the structure 20 which is highly possible to collapse soon based on structural analysis of the fired structure 20 using the cumulative displacement data (Step S116). The collapse prediction unit 213 extracts the three collapse sign characteristics, that is, the displacement, the natural frequency, and the damping ratio of the structure 20 on fire, as shown in FIG. 10. In the collapse prediction unit 213, any particular portion of the structure 20 which is highly possible to collapse in the near future can be estimated through the pattern recognition based structural analysis using the extracted three collapse sign characteristics data, as shown in FIG. 11. The control unit 219 may control the estimated risky portions which will be likely to collapse to be displayed on the display unit 216 with notable change of the color of the sensors 100.

The prediction information generated by the collapse prediction unit 213 is provided to a collapse warning unit 214 that calculates a collapse index and issues early-warning for the potential collapse of the structure 20 on fire based on the calculated collapse index (Step S118). The collapse warning unit 214 can make a warning message to be provided to the firefighters on the matter of whether they are allowed to enter the structure 20 on fire or not based on the estimated remaining time till the potential collapse of the structure 20. In step 118, if there remains enough time to collapse of the structure 20, an on-site firefighting commander can determine whether the firefighters should enter the structure 20 on fire to fight the fire or not, taking into account the collapse prediction information estimated by the computer 200. In other words, if there is enough time till collapse of the structure 20 in step S118, entry of the firefighters into the structure 20 on fire for firefighting can be ordered (Step S120). Otherwise, entry into the structure 20 for firefighting may be postponed or withdrawal from the structure 20 may be urgently ordered to the firefighters in the structure 20 (Step S122). Therefore, it is possible to prevent damage of the firefighters due to collapse of the fired structure in advance.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A system for predicting collapse of a structure on fire, comprising:
at least one throw-type sensor for measuring a collapse characteristic of a structure on fire after having been thrown into the structure in a fireplace and wirelessly transmitting measured data; and
a computer for receiving the measured data transmitted from the at least one throw-type sensor and predicting whether or not the structure on fire will collapse by analyzing the measured data.

2. The system of claim 1, wherein the throw-type sensor includes an accelerometer and a velocimeter.

3. The system of claim 2, wherein the throw-type sensor further includes at least any one among a GPS sensor, a camera, and a temperature sensor.

4. The system of claim 3, wherein the computer comprises a sensor position estimating unit for calculating a 3-dimensional (3D) absolute coordinate of a position of the at least one throw-type sensor based on GPS data, and estimating the position of the at least one throw-type sensor on a design drawing of the structure by figuring out a structural element of the structure on which the at least one throw-type sensor is positioned based on image data from the camera.

5. The system of claim 2, wherein the computer comprises a displacement estimation unit for correcting a bias value of received acceleration data and velocity data.

6. The system of claim 5, wherein the displacement estimation unit comprises a Kalman filter for calculating velocity data by integrating once the acceleration data measured by the throw-type sensor, and the bias value by linearly combining the calculated velocity data and the velocity data measured by the throw-type sensor; and a bias compensator for offsetting the bias value included in displacement data obtained by integrating twice the measured acceleration data, by the calculated bias value, to obtain bias-error-free displacement data.

7. The system of claim 5, wherein the computer comprises a collapse prediction unit for extracting collapse sign characteristic data from the bias-error-free displacement data estimated by the displacement estimation unit and predicting a potential collapse portion of the structure on fire through a pattern-recognition based structural analysis based on the extracted collapse sign characteristic data.

8. The system of claim 7, wherein the collapse sign characteristic data include displacement data, natural frequency data, and damping ratio data.

9. The system of claim 7, wherein the computer further comprises a collapse warning unit for estimating a potential collapse time of the structure based on an analysis result by the collapse prediction unit, and warning a remaining time till the estimated potential collapse time.

10. The system of claim 1, wherein the throw-type sensor comprises a fire-resistant shell.

11. A method for predicting collapse of a structure on fire, comprising:
communicating, by a computing device, with a plurality of throw-type sensors thrown into the structure on fire to receive measured data for a collapse characteristic of the structure from each of the plurality of the throw-type sensors; and
predicting, by the computing device, whether or not the structure on fire will collapse by analyzing the measured data for the collapse characteristic of the structure.

12. The method of claim 11, wherein the measured data for the collapse characteristic of the structure includes acceleration data, velocity data and position data.

13. The method of claim 11, wherein the predicting step comprises: estimating, by the computing device, attached positions of the throw-type sensors on the structure based on position data received from the throw-type sensors; calculating, by the computing device, displacement data without a bias error which is removed by combining acceleration data and velocity data received from the plurality of throw-type sensors at their attached positions on the structure; and estimating, by the computing device, a potential collapse portion of the structure on fire based on the calculated displacement data.

14. The method of claim 13, wherein the predicting step further comprises a step of correcting a bias value of the received acceleration data and velocity data.

15. The method of claim 13, wherein the predicting step further comprises the steps of: calculating a velocity data by integrating once the acceleration data measured by each of the plurality of throw-type sensors, and a bias value by linearly combining the calculated velocity data and the velocity data measured by the throw-type sensor; and offsetting the bias value included in the displacement data obtained by integrating twice the measured acceleration data by the calculated bias value to obtain the displacement data without the bias error.

16. The method of claim 13, wherein the predicting step further comprises the steps of: extracting a collapse sign characteristic from the displacement data; and predicting a potential collapse portion of the structure on fire through a pattern-recognition based structural analysis based on the extracted collapse sign characteristic.

17. The method of claim 16, wherein the collapse sign characteristic includes a displacement, a natural frequency and a damping ratio.

18. The method of claim 11, further comprising a step of estimating, by the computing device, a potential collapse time based on an analysis a collapse prediction algorithm.

19. The method of claim 18, further comprising a step of warning a remaining time till the estimated potential collapse time.

20. The method of claim 11, further comprising the steps of: calculating a 3-dimensional absolute coordinate of positions of the plurality of throw-type sensors based on GPS data; and estimating the positions of the plurality of throw-type sensors on a design drawing of the structure by figuring out a structural element of the structure on which the plurality of throw-type sensors are positioned based on image data from a camera in each of the plurality of throw-type sensors.
